(19) United States
(12) Patent Application Publication
(10) Pub. No.: US 2006/0226583 A1
(43) Pub. Date: Oct. 12, 2006

(54) Light directing film

(76) Inventors: Patrick H. Marushin, St. Paul, MN (US); David M. Foresyth, Wilmington, MA (US); Todd M. Johnson, St. Paul, MN (US); Mark E. Gardiner, Santa Rosa, CA (US)

Correspondence Address: 3M INNOVATIVE PROPERTIES COMPANY, PO BOX 33427, ST. PAUL, MN, 55133-3427, US

(21) Appl. No.: 11/098,241

(22) Filed: Apr. 4, 2005

(51) Int. Cl. B29C 43/02; B29C 51/00; B29C 49/00; B29D 29/00; B29D 24/00

(52) U.S. Cl. 264/553

(57) ABSTRACT

A light directing film and an optical system incorporating same are disclosed. The light directing film includes a first major surface and a microstructured second major surface. The microstructured second major surface has a periodic microstructured pattern. A plurality of extended microstructures form each period. The period is in the range from about 200 microns to about 400 microns. About 15 to 25 percent of the plurality of extended microstructures that form each period form a first group. A planar film that is placed adjacent the second major surface makes contact with substantially all the extended microstructures in the first group, but does not make contact with substantially all extended microstructures that are not in the first group.

### FIELD OF THE INVENTION

This invention generally relates to light directing films and displays incorporating same. In particular, the invention relates to light directing films having periodic microstructured patterns where for each period, the peaks of some microstructures are taller than the peaks of some other microstructures.

### BACKGROUND

Backlit flat panel displays often incorporate one or more microstructured films to enhance display brightness along a pre-determined direction, typically, where a user is expected to be located. Such a microstructured film typically has a prismatic cross-sectional profile and extends linearly along a direction normal to the cross-section.

In some applications a single prismatic film is used, while in others two crossed prismatic films are employed, in which case, the two crossed prismatic films are often oriented normal to each other.

### SUMMARY OF THE INVENTION

Generally, the present invention relates to light directing films. The present invention also relates to displays incorporating light directing films.

In one embodiment of the invention, a light directing film includes a first major surface and a microstructured second major surface. The microstructured second major surface has a periodic microstructured pattern. A plurality of extended prisms form each period of the periodic microstructured pattern. The period is in the range from about 200 microns to about 400 microns. Each extended prism has a peak. Each extended prism has a peak height measured from the peak to a common reference plane. The plurality of extended prisms include a first group of extended prisms. The peaks of the extended prisms in the first group of extended prisms is at a first height. The first height is greater than the peak height of any extended prism in the plurality of extended prisms that is not in the first group of extended prisms.

In another embodiment of the invention, a light directing film includes a first major surface and a microstructured second major surface. The microstructured second major surface has a periodic microstructured pattern. A plurality of extended microstructures form each period of the periodic microstructured pattern. The period is in the range from about 200 microns to about 400 microns. About 15 to 25 percent of the plurality of extended microstructures that form each period form a first group. A planar film that is placed adjacent the second major surface makes contact with substantially all the extended microstructures in the first group. The planar film does not make contact with substantially all extended microstructures that are not in the first group.

### BRIEF DESCRIPTION OF DRAWINGS

The invention may be more completely understood and appreciated in consideration of the following detailed description of various embodiments of the invention in connection with the accompanying drawings, in which:

FIG. 1 is a three-dimensional view of a conventional light directing film;

FIG. 2 is a schematic side-view of a light directing film in accordance with one embodiment of the invention;

FIG. 3 is an extended prism in accordance with one embodiment of the invention;

FIG. 4 illustrates the concept of optical coupling (wet out);

FIGS. 5A-5E are exemplary cross-sectional profiles of prisms of the invention;

FIG. 6 is a magnified portion of the light directing film shown in FIG. 2;

FIG. 7 is a schematic side-view of a light directing film in accordance with one embodiment of the invention;

FIG. 8 is a plot of optical coupling (wet out) measured as a function of unit cell width for several light directing films;

FIG. 9 is a schematic side-view of a light guide assembly in accordance with one embodiment of the invention; and

FIG. 10 is a schematic side-view of an illumination assembly in accordance with another embodiment of the invention.

### DETAILED DESCRIPTION

The present invention generally applies to prismatic light directing films that substantially maintain their intended cross-sectional profile during manufacturing, processing, and use. The invention is further applicable to backlit liquid crystal displays employing at least one prismatic light directing film where it is desirable to minimize optical coupling between the prismatic film and a planar optical film that may be located in close proximity to the prismatic film. In the specification, a same reference numeral used in multiple figures refers to same or similar elements having same or similar properties and functionalities.

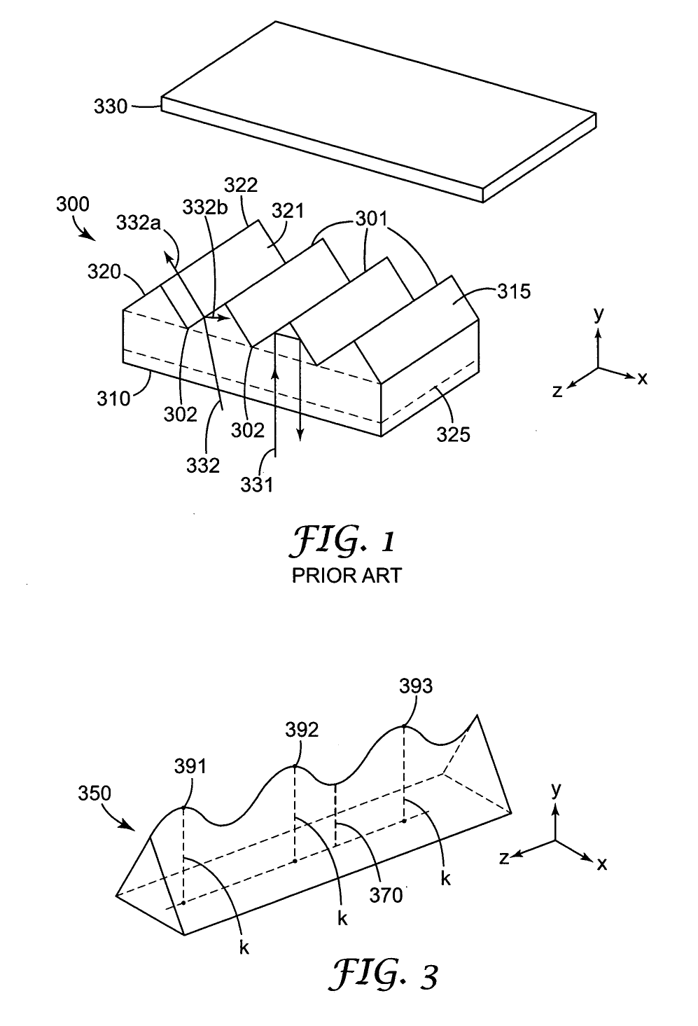

FIG. 1 is a three-dimensional view of a conventional prismatic light directing film 300. Films similar to film 300 have been previously disclosed, for example, in U.S. Pat. Nos. 4,906,070 and 5,056,892. Film 300 has a major first surface 310 and a microstructured second major surface 320. Film 300 further includes a plurality of linear prisms 315 each of which has two side surfaces, such as surfaces 321 and 322, and extends linearly along the z-axis. Film 300 has a prismatic cross-section in the xy-plane. Film 300 further has a plurality of peaks 301 and grooves 302. Peaks 301 have a same height as measured from a common reference plane 325 placed any where between first and second major surfaces 310 and 320, respectively. For an equal height prism structure, the peaks of all the linear prisms lie in a same plane, meaning that a planar film 330 brought into contact with light directing film 300, contacts all the peaks of the linear prisms of film 300.

The operation of conventional light directing film 300 has been previously described, for example, in U.S. Pat. No. 5,056,892. In summary, light rays, such as ray 331, that strike structured surfaces 321 or 322 at incident angles larger than the critical angle are totally internally reflected back. On the other hand, rays, such as ray 332, which are incident on surfaces 321 or 322 at angles less than the critical angle are partly transmitted (such as ray 332a) and partly reflected (such as ray 332b). An end result is that, when employed in a display, such as a liquid crystal display, light directing film 300 can result in display brightness enhancement by recycling light that is totally internally reflected.

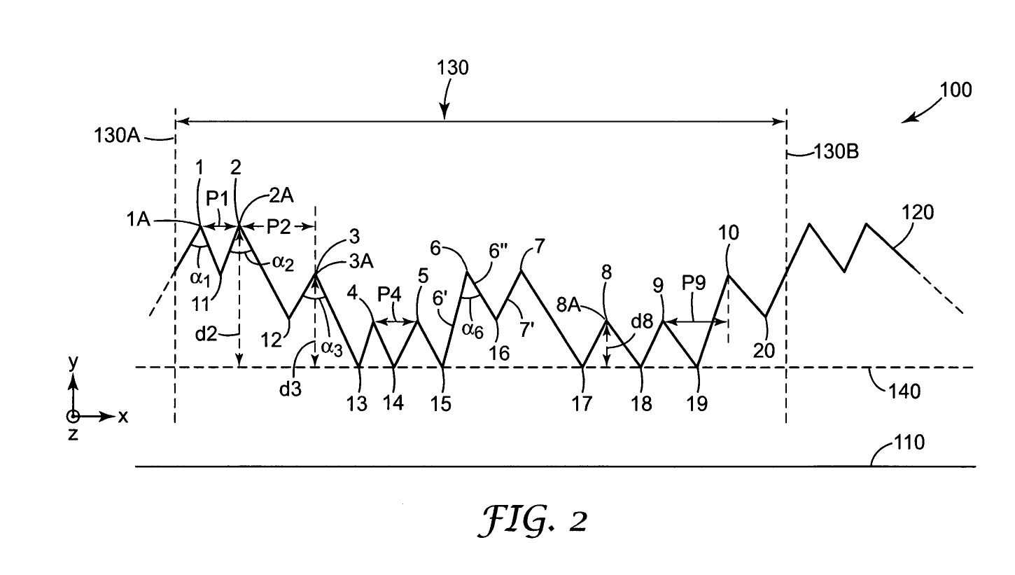

FIG. 2 is a schematic side-view (cross-section in the xy-plane) of a light directing film 100 in accordance with one particular embodiment of the invention. Light directing film 100 has a first major surface 110 and a microstructured second major surface 120. Major surface 120 has a periodic microstructured pattern. One such period is region 130 confined between two dashed boundary lines 130A and 130B. In one aspect of the invention, a plurality of extended prisms forms each period of major surface 120, such as period 130, where the prisms can, for example, extend generally along the z-axis, where the z-axis in FIG. 2 is normal to the page. FIG. 2 shows 10 extended prisms forming period 130, although, in general, the number of prisms forming period 130 may be less or greater than 10. In some applications, period 130 may include other elements in addition to extended prisms. Such elements may include a gap or a separation between adjacent extended prisms, or any element that may be designed to serve a primary purpose other than directing light or enhancing brightness. Each extended prism can be a linear prism where the linear direction can, for example, be along the z-axis.

For any cross-section of light directing film 100, such as the one shown in FIG. 2, each linear prism in period 130 has an apex. For example, prism 2 has an apex 2A, prism 3 has an apex 3A, and prism 8 has an apex 8A. Furthermore, each apex has an apex height, where the apex height is measured from the apex to a common reference plane 140 located somewhere between first and second major surfaces 110 and 120, respectively. For example, apex 2A has an apex height d2 (which is the same as the height of apex 1A), apex 3A has an apex height d3, and apex 8A has an apex height d8.

The apex height of each linear prism can remain the same or change along the linear extent of the linear prism. For example, FIG. 3 shows an extended prism 350 where the prism's apex height 370 changes along the z-axis. Each prism apex having the largest apex height defines a prism peak with the largest apex height referred to as the peak height. Accordingly, each extended prism has one peak height that corresponds to one or more prism peaks located along the extended direction of the prism. For example, referring to FIG. 3, linear prism 350 includes three peaks 391, 392, and 393 all having the same peak height “k.”

For simplicity, and without loss of generality, the apex height of each linear prism in FIG. 2 is assumed to remain constant along the prism's linear direction, in which case, the apex height is the same as the peak height.

Each apex of each linear prism of light directing film has an apex angle which is the angle formed by the two sides of the prism. For example, referring to FIG. 2, prism 6 has an apex angle α₆, formed by sides 6′ and 6″ of prism 6. Similarly, prism 1 has an apex angle α₁, prism 2 has an apex angle α₂, and prism 3 has an apex angle α₃. In the invention, the apex angle of a prism peak is referred to as a peak angle. In general, the prisms in period 130 need not have the same apex height and/or angle, although in some applications the prisms may have the same apex height and/or angle.

When used in a display, light directing film 100 may be used with the prisms facing up (as shown, for example, in FIG. 9) or facing down. In general, the peak angle can be any angle suitable for directing light. According to the present invention, and particularly in a prism-up configuration, such as the arrangement shown in FIG. 9, the peak angle is preferably in the range from about 70 to 120 degrees, more preferably in the range from about 80 to 110 degrees, and even more preferably in the range from about 85 to 105 degrees.

According to one particular embodiment of the invention, period 130 includes a first group of linear prisms, where the linear prisms in the first group have substantially the same peak height which is greater than the peak height of any other linear prism in period 130. For example, prisms 1 and 2 in period 130 have the same peak height d2 and form a first group of linear prisms. Furthermore, peak height d2 is greater than any other peak height in period 130, such as peak heights d3 and d8.

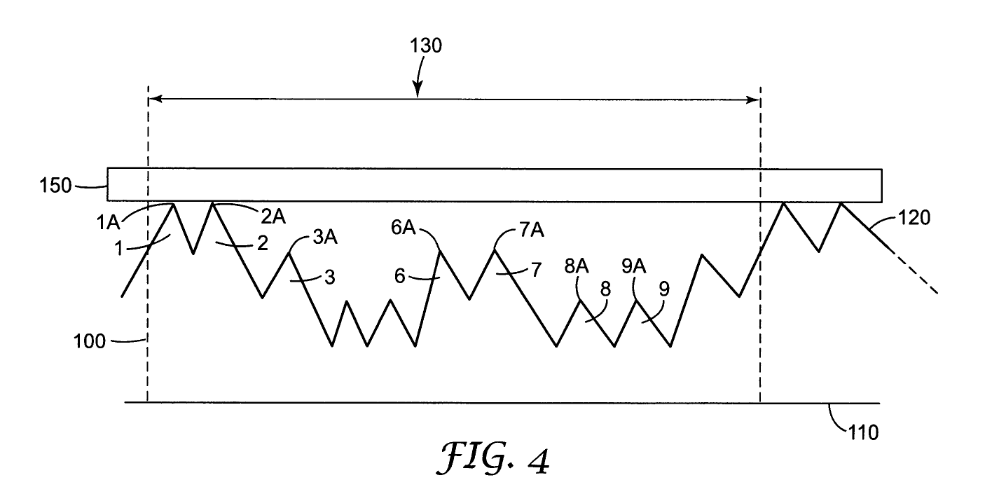

An advantage of unequal prism heights is reduced optical coupling, sometimes referred to as wet-out, between a planar film and microstructured surface 120 when the two are placed in close proximity to each other. An example of optical coupling is described in reference to FIG. 4 where a planar film 150 is placed in close proximity to microstructured second major surface 120 of light directing film 100. In FIG. 4, optical coupling between films 100 and 150 can occur in locations where the two films are sufficiently close to each other, which in general means that in these locations the two films are in direct or near-direct contact with one another. For example, planar film 150 may be sufficiently close to film 100 at peaks 1A and 2A (corresponding to linear prisms 1 and 2, respectively) to allow optical coupling or wet out between the two films at or near the two peaks. In general, optical coupling occurs because of light leakage between the two films at points of contact or near contact because of a reduction in reflection or a frustration of total internal reflection of light at these points. Wet out can also occur, for example, due to evanescent optical coupling of light between films 150 and 100 at areas where the two films are sufficiently close to one another.

Optical coupling can lead to uneven or non-uniform light transmission between films 100 and 150 resulting in a non-uniform appearance. For example, light directing film 100 may be used in a liquid crystal display (LCD) to enhance brightness of light directed in a given direction. Film 150 may be another film used in the display. For example, film 150 may be an optical diffuser, a polarizer, a retarder, or a light directing film similar to film 100 but oriented differently. Optical coupling between films 150 and 100 in the display can lead to non-uniform light transmission in the display resulting in undesirable bright spots or streaks that are visible to a viewer. Optical coupling can occur, for example, if film 150 is simply placed on top of film 100, meaning that film 100 supports film 150, thereby resulting in areas of contact between the two films, for example, at or near the tallest peaks of film 100. As another example, optical coupling can occur when film 150 bends or has a curl, causing it to become sufficiently close to film 100 to allow optical coupling.

It is, in general, desirable to reduce or eliminate optical coupling between films 150 and 100 by reducing the areas of contact or near contact between the two films. Methods for reducing optical coupling or wet out have been previously disclosed. For example, U.S. Pat. No. 5,771,328 discloses a variable height structured surface for reducing optical coupling. The prisms in film 100 are preferably sufficiently uneven in height so that in a given period, such as period 130, prisms other than prisms 1 and 2 are sufficiently far from film 150 as to not contribute to wet out. For example, peaks 6A, 7A, 8A, and 9A (corresponding to linear prisms 6, 7, 8, and 9, respectively) are sufficiently far from film 150 that none contributes to wet out or optical coupling between films 150 and 100. The difference in peak heights between the linear prisms in the first group and all the other prisms in period 130, is preferably at least 0.25 microns, more preferably at least 0.5 microns, and even more preferably at least 0.75 microns.

A potential consequence of unequal prism heights is a visual perception of artifacts such as lines or granularity in film 100 itself. In fact, such artifacts may be noticeable by a viewer even where light directing film 100 is embedded inside a display, such as an LCD. Such undesirable artifacts are especially noticeable in liquid crystal displays that employ internal drive circuitry technologies such as LTPS (low temperature poly-silicon) or CGS (continuous grain silicon) that are capable of producing pixels with high aperture ratios. Variation in prism height can be visible in a display leading to cosmetically unacceptable display appearance.

Referring back to FIG. 2, film 100 further has a plurality of grooves such as grooves 11 through 20 in period 130. Each groove is formed by two sides of neighboring linear prisms, in particular, the two sides facing each other. For example, groove 16 is formed by neighboring prisms 6 and 7, in particular, by side 6″ of prism 6 and side 7′ of prism 7 where sides 6″ and 7′ face each other. Accordingly, each linear prism can have a peak and two associated grooves, one on each side of the peak. For example, prism 8 has a peak 8A and two associated grooves 17 and 18.

In the present invention, the lateral distance between adjacent peaks is referred to as a pitch. For example, distance P2 (FIG. 2) measured along the x-axis between peaks of prisms 2 and 3 is a pitch. As another example, distance P4, measured along the x-axis between peaks of prisms 4 and 5, is another pitch. Similarly, distance P9, measured along the x-axis between peaks of prisms 9 and 10, is a pitch. In general, pitches in film 100 within period 130 are not equal. For example, P2 can be different from P4 which, in turn, can be different from P9. In some embodiments of the invention, film 100 has a constant pitch, meaning, for example, that distances P1, P2, P4, and P9 are equal. Furthermore, according to a preferred embodiment of the invention, a pitch does not change along the linear dimension of film 100, meaning that for different cross-sections of film 100 that are normal to the linear direction of the film, the lateral distance between the same two adjacent linear prisms remains unchanged. As an example, pitch P2 can remain unchanged along the linear direction of film 100.

A pitch of each linear prism in period 130 is preferably in the range from about 5 to 500 microns, more preferably in the range from about 10 to 200 microns, and even more preferably in the range from about 10 to 100 microns.

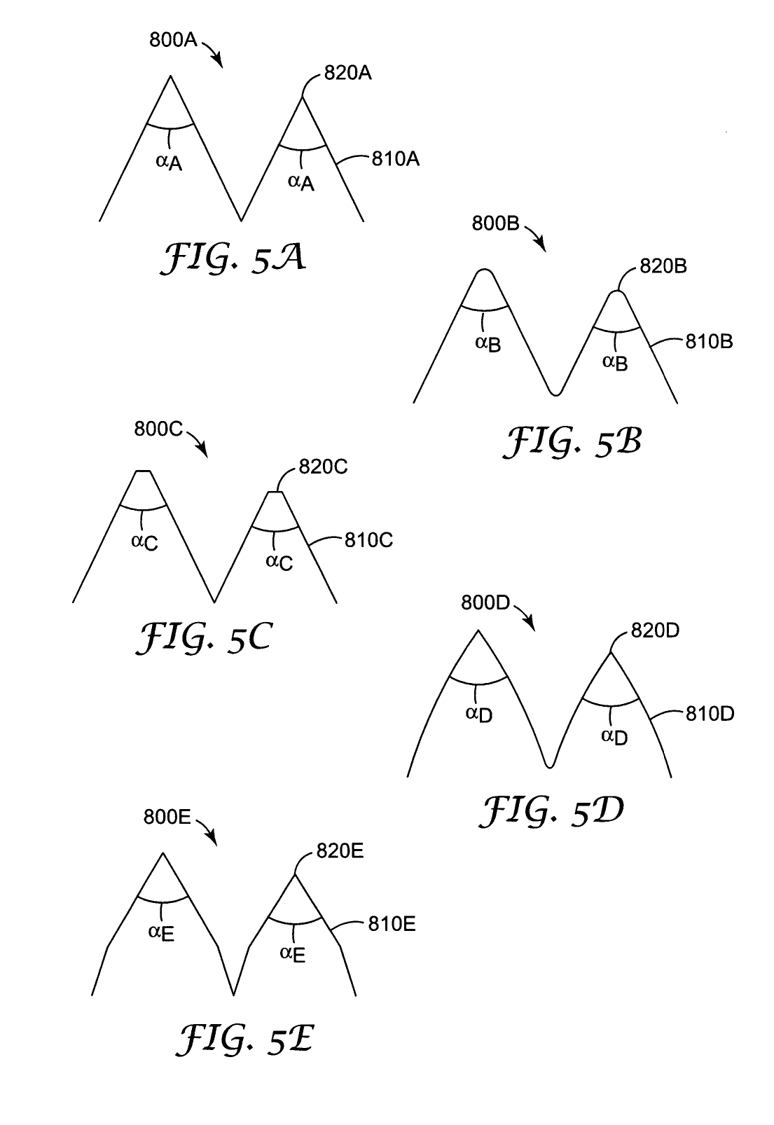

The exemplary light directing film 100 of FIG. 2 illustrates linear prisms each having a triangular profile. In general, any extended microstructure may be used that is capable of directing light. For example, the extended prisms of FIG. 2 may have any profile that may be suitable for directing light. Examples of extended prisms having different profiles are shown in FIGS. 5A-5E. In FIG. 5A, extended prisms 800A have straight sides 810A, sharp apexes 820A, sharp grooves, and apex angle α_{A}, similar to the extended prisms of FIG. 2. Extended prisms 800B in FIG. 5B have straight sides 810B, round apexes 820B, round grooves, and apex angles α_{B}. The radius of curvature of the apex or the groove can, for example, be in the range from about 1 to 100 microns. In FIG. 5C, extended prisms 800C have straight sides 810C, flat apexes 820C, sharp grooves, and apex angle α_{C}. As a further example, extended prisms 800D in FIG. 5D have curved sides 810D, sharp apexes 820D, round grooves, and apex angle α_{D}. As yet another example, extended prisms 800E in FIG. 5E have piece-wise linear sides 810E, sharp apexes 820E, sharp grooves, and apex angle α_{E}.

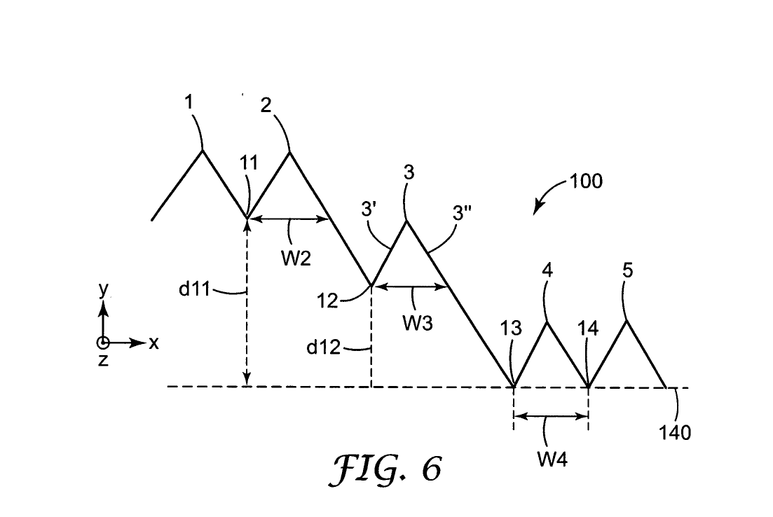

Additional characteristics of light directing film 100 are described in reference to FIG. 6 which shows a magnified portion of film 100. In particular, FIG. 6 illustrates portions of prisms 1 through 5. Each groove in film 100 has a groove height measured from the groove to common reference plane 140. For example, groove 11 has a groove height d11 and groove 12 has a groove height d12. As another example, each of grooves 13 and 14 has a groove height equal to zero because the exemplary common reference plane 140 was arbitrarily chosen to coincide with the lowest grooves in film 100.

Furthermore, referring to FIGS. 2 and 6, each linear prism in period 130 has a prism width which is the smallest lateral distance between the two sides of the prism along a direction that includes at least one of the two grooves associated with the prism. For example, prism 2 has a prism width W2, prism 3 has a prism width W3 (between sides 3′ and 3″), and prism 4 has a prism width W4. According to one embodiment of the invention, the prism width of a linear prism changes along the linear direction of film 100. For example, prism width W2 can very along the linear direction of film 100.

Referring back to FIG. 2, two out of ten linear prisms in period 130 form the first group of linear prisms. As such, 20 percent of the linear prisms in period 130 are in the first group. In general, the first group of linear prisms can have more or less than two prisms. The percent number of linear prisms in period 130 that belong to the first group, the percent being referred to as T, can be less or greater than 20. In general, the number of linear prisms in the first group of linear prisms can be any percent of the total number of linear prisms in period 130. The number of linear prisms in the first group of linear prisms is preferably in the range from about 5 to 50 percent of the total number of linear prisms in period 130. The range is more preferably from about 5 to 40 percent, even more preferably from about 5 to 30, and even more preferably from about 5 to 25 percent. According to one embodiment of the invention, the number of linear prisms in the first group of linear prisms is preferably in the range from about 10 to 40 percent of the total number of linear prisms in period 130. The range is more preferably from about 15 to 30 percent, and even more preferably from about 15 to 25 percent.

As discussed previously, unequal height prisms in a light directing film 100 that is employed in a display can lead to undesirable cosmetic effects in the display. As height unevenness in the prisms of film 100 is reduced, the undesirable granular appearance becomes less noticeable. At the same time, however, a reduction in the unevenness of prism heights can lead to increased optical coupling.

Unequal height prisms can also make film 100 more susceptible to peak (or apex) deformation from an externally applied pressure, such as pressures resulting from web handling, converting, or use. Generally, taller prisms in period 130 are more susceptible to peak deformation as they can more readily make contact with external objects. For example, referring to FIG. 4, if an external force is applied to film 100 by pressing planar film 150 against film 100, the applied force is more likely to deform peaks 1A and 2A than shorter peaks such as peak 3A, and even more likely than even shorter peaks such as peak 8A. In general, for a given external force applied to film 100, as the number of tallest peaks in period 130 increases, peak deformation decreases. This is so, because as the number of tallest prisms increases, an applied external force is distributed among more peaks, thus reducing the pressure applied to each peak. Therefore, in general, to reduce the likelihood of peak deformation during production or use, it is desirable to reduce the unevenness in prism height of the linear prisms in light directing film 100.

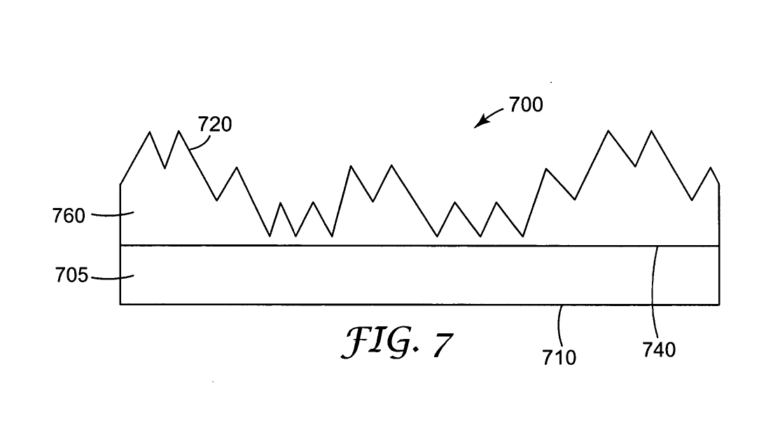

Light directing film 100 may be a single layer film as shown in FIG. 2. Light directing film 100 may include more than one layer, such as light directing film 700, a side-view of which is shown schematically in FIG. 7. Light directing film 700 includes a microstructured film 760 disposed on a substrate 705. Light directing film 700 further includes a first major surface 710 and a microstructured second major surface 720, where surface 720 can be similar to microstructured surface 120 of FIG. 2. Microstructured film 760 may, for example, be coated on a surface 740 of substrate 705. Surface 740 can be a common reference plane, similar to common reference plane 140 of FIG. 2, from which the heights of linear prisms of microstructured film 760 may be measured. Substrate 705 may be rigid or flexible. Substrate 705 may be a single film or may include multilayers. Substrate 705 may have light polarizing properties by, for example, absorption, reflection, or scattering of light. For example, substrate 705 may be a multilayer optical film, such as those disclosed in U.S. Pat. No. 5,882,774. Substrate 705, microstructured film 760, and light directing film 100 may be made of any suitable, preferably optically transmissive, material. Examples include polycarbonate, acrylic, polyethylene terephthalate (PET), polyvinyl chloride (PVC), polysulfone, 2,6-polyethylene naphthalate (PEN ) or a co-polymer derived from ethylene glycol, naphthalene dicarboxylic acid and some other acids such as terephthalate (co-PEN), and the like.

To examine optical coupling as a function of relevant characteristics of microstructured surface 120, four different samples (designated AA, BB, CC, and DD), each similar to film 100, were prepared. The relevant characteristics of each sample are given in Table I below:

TABLE I

| | Period | Pitch | Peak Angle | |
|---|---|---|---|---|
| Sample | (microns) | (microns) | (Degrees) | T |
| AA | 50 | 50 | 90 | 100 |
| BB | 264 | 24 | 90 | 24 |
| CC | 475.2 | 24 | 90 | 11.1 |
| DD | 792 | 24 | 90 | 6.7 |

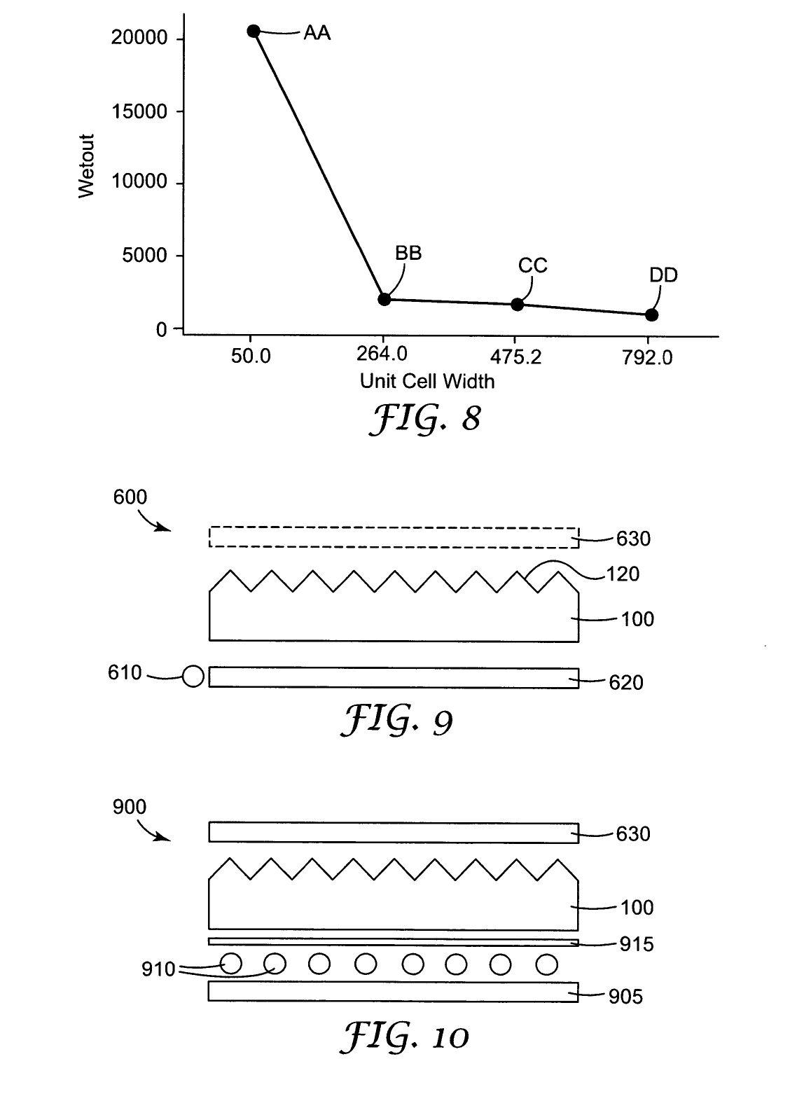

In Table I, period refers to period 130, sometimes referred to as unit cell width, pitch refers to the prism pitch which was constant for each sample, and peak angle refers to the angle of the prism at the peak. T is percent number of linear prisms in period 30 that form the first group of linear prisms. For each sample, wet out was measured by first, placing the test sample on a uniformly lit commercially available light box with the structured surface of the sample facing up (away from the light box). Next, a second microstructured sample, similar to the test sample, was placed on the test sample with the structured surface of the second sample facing up. Next, a 500 gram optically transparent weight was placed on the second sample to bring the test sample into sufficient proximity to the second sample. Next, a digital camera was used to capture and record an image of the optical coupling between the test and second samples. The second microstructured sample has been found to improve the contrast of the optical coupling image. The unexpected results are plotted in FIG. 8, where the horizontal axis is the sample period or unit cell width in microns, and the vertical axis is the amount of wet out in arbitrary units. As can be seen from the graph in FIG. 8, wet out decreases as the period of the microstructured surface 120, that is, period 130, is increased. At the same time, as can be seen from Table I, a smaller period corresponds to a greater T. As such, an overall desirable or optimum operating point is located around the point representing sample BB, defining a knee in the graph of FIG. 8.

In other words, sample BB represents an optimum or close to optimum balance between a desire, on the one hand, to increase the number of tall prisms in a period in order to reduce optical coupling, and a desire, on the other hand, to reduce unevenness in prism heights in period 130 in order to reduce peak deformation and granularity.

According to the present invention, period 130 of film 100 is preferably in the range from about 200 to about 400 microns, more preferably in the range from about 200 to about 350 microns, more preferably in the range from about 200 to about 300 microns, more preferably in the range from about 200 to about 280 microns, and even more preferably in the range from about 220 to about 280 microns.

FIG. 9 shows a schematic side-view of a light guide assembly 600 in accordance with one particular embodiment of the invention. Light guide assembly 600 can be used in any liquid crystal device for displaying information. Light guide assembly 600 includes a light source 610, a light guide 620, and light directing film 100. Although microstructured surface 120 of film 100 in FIG. 9 is shown to face away from light guide 620, in some applications, microstructured surface 120 can face light guide 620. Light guide assembly 600 can further include an optional film 630, similar to film 100, but oriented differently. For example, direction of extended prisms in films 100 and 630 can be orthogonal to one another. Light guide assembly 600 can further include additional films or components not explicitly shown in FIG. 9, such as reflectors, diffusers such as diffuser plates, reflective polarizers, protective films, mounting frames, or shading frames such as masks.

FIG. 10 shows a schematic side-view of an illumination assembly 900 in accordance with another embodiment of the invention. Illumination assembly 900 can, for example, be used in any liquid crystal device for displaying information, such as an LCD television. Illumination assembly 900 includes a back reflector 905, a diffuser sheet or plate 915, and a plurality of light sources 910 positioned between back reflector 905 and diffuser 915. Back reflector 905 may be a diffuse reflector.

All patents, patent applications, and other publications cited above are incorporated by reference into this document as if reproduced in full. While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

What is claimed is:

1. A light directing film comprising:
a first major surface; and
a microstructured second major surface having a periodic microstructured pattern, a plurality of extended prisms forming each period of the periodic microstructured pattern, the period being in the range from about 200 microns to about 400 microns, each extended prism in the plurality of extended prisms having a peak and a peak height measured from the peak to a common reference plane disposed between the first and second major surfaces, the plurality of extended prisms including a first group of extended prisms, the peaks of the extended prisms in the first group of extended prisms being at a first height, the first height being greater than the peak height of any extended prism in the plurality of extended prisms not in the first group of extended prisms.

2. The light directing film of claim 1, wherein the period is in the range from about 200 microns to about 350 microns.

3. The light directing film of claim 1, wherein the period is in the range from about 200 microns to about 300 microns.

4. The light directing film of claim 1, wherein the period is in the range from about 200 microns to about 280 microns.

5. The light directing film of claim 1, wherein the period is in the range from about 220 microns to about 280 microns.

6. The light directing film of claim 1, wherein the number of extended prisms in the first group of extended prisms is about 5 to 50 percent of the total number of extended prisms in the plurality of extended prisms forming each period.

7. The light directing film of claim 1, wherein the number of extended prisms in the first group of extended prisms is about 10 to 40 percent of the total number of extended prisms in the plurality of extended prisms forming each period.

8. The light directing film of claim 1, wherein the number of extended prisms in the first group of extended prisms is about 15 to 30 percent of the total number of extended prisms in the plurality of extended prisms forming each period.

9. The light directing film of claim 1, wherein the number of extended prisms in the first group of extended prisms is about 15 to 25 percent of the total number of extended prisms in the plurality of extended prisms forming each period.

10. The light directing film of claim 1, each extended prism in the plurality of extended prisms having a peak angle, the peak angle being in the range from 70 to 120 degrees.

11. The light directing film of claim 1, each extended prism in the plurality of extended prisms having a peak angle, the peak angle being in the range from 80 to 110 degrees.

12. The light directing film of claim 1, each extended prism in the plurality of extended prisms having a peak angle, the peak angle being in the range from 85 to 105 degrees.

13. The light directing film of claim 1, wherein at least one of the extended prisms in the first group of extended prisms has multiple peaks, each peak being at the first height.

14. The light directing film of claim 1, wherein at least one of the extended prisms in the plurality of extended prisms not in the first group of extended prisms has multiple peaks, each peak being at a second height, the second height being different than the first height.

15. The light directing film of claim 14, wherein at least one of the extended prisms in the plurality of extended prisms not in the first group of extended prisms has a peak at a third height, the third height being different than the first and second heights.

16. The light directing film of claim 1, wherein at least two adjacent extended prisms not in the first group of extended prisms have the same peak height.

17. The light directing film of claim 1, wherein about 5 to 50 percent of the plurality of extended prisms forming each period form the first group of extended prisms.

18. The light directing film of claim 1, wherein about 10 to 40 percent of the plurality of extended prisms forming each period form the first group of extended prisms.

19. The light directing film of claim 1, wherein about 15 to 30 percent of the plurality of extended prisms forming each period form the first group of extended prisms.

20. The light directing film of claim 1, wherein about 15 to 25 percent of the plurality of extended prisms forming each period form the first group of extended prisms.

21. The light directing film of claim 1, wherein the first height is greater than the peak height of any extended prism in the plurality of extended prisms not in the first group of extended prisms by at least 0.25 microns.

22. The light directing film of claim 1, wherein the first height is greater than the peak height of any extended prism in the plurality of extended prisms not in the first group of extended prisms by at least 0.5 microns.

23. The light directing film of claim 1, wherein the first height is greater than the peak height of any extended prism in the plurality of extended prisms not in the first group of extended prisms by at least 0.75 microns.

24. The light directing film of claim 1, wherein a width of at least one extended prism in the plurality of extended prisms forming each period changes along an extended direction of the prism.

25. The light directing film of claim 1, wherein at least one extended prism in the plurality of extended prisms forming each period has a round peak.

26. A light guide assembly for use in a liquid crystal display, the light guide assembly comprising at least one film of claim 1.

27. A light guide assembly for use in a liquid crystal display, the light guide assembly comprising two films of claim 1, wherein the extended prisms of the first film are oriented in a different direction than the extended prisms of the second film.

28. A light directing film comprising:
a first major surface; and
a microstructured second major surface having a periodic microstructured pattern, a plurality of extended microstructures forming each period of the periodic microstructured pattern, the period being in the range from about 200 microns to about 400 microns, about 15 to 25 percent of the plurality of extended microstructures that form each period forming a first group, wherein a planar film placed adjacent the second major surface makes contact with substantially all the extended microstructures in the first group, but not with any extended microstructure not in the first group.
